(19) United States
(12) Patent Application Publication
(10) Pub. No.: US 2009/0253419 A1
(43) Pub. Date: Oct. 8, 2009

(54) METHOD FOR REDIRECTING TEXT MESSAGES AND MOBILE PHONE CALLS

(75) Inventor: Anthony Howard Phillips, North Baddesley (GB)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/098,731

(22) Filed: Apr. 7, 2008

(51) Int. Cl. H04M 3/58

(52) U.S. Cl. 455/417

(57) ABSTRACT

The present disclosure is a method or redirecting text messages and mobile phone calls. The method for redirecting communication may receive a communication, detect a recipient's failure to receive communication, request to redirect communication and transfer communication to an alternate recipient.

### TECHNICAL FIELD

The present disclosure generally relates to the field of communication, and more particularly to a method for redirecting text messages and mobile phone calls.

### BACKGROUND

Mobile cellular coverage remains patchy and inconsistent. Whether the communication is in the form of voice communication or text communication, a desired recipient may not receive the communication at the appropriate time. Cellular coverage may be limited by geographic location (rural areas) and is limited by loss of signal conditions, for example, within a building. Cellular communication is also prevented when the desired recipient has their phone switched off. However, there are instances when it would be beneficial to get an urgent message to a desired recipient.

### SUMMARY

Accordingly, the present disclosure is directed to a method for redirecting text messages and mobile phone calls. In an embodiment of the invention, method for redirecting communication may include reception of a communication, detection of recipient's failure to receive communication, request to redirect communication, and transfer of communication to an alternate recipient.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 illustrates a flow diagram for redirecting communication in accordance with an embodiment of the invention;

FIG. 2 illustrates a diagram of a routing system in accordance with an embodiment of the present invention.

### DETAILED DESCRIPTION

Reference will now be made in detail to the presently preferred embodiments of the invention, examples of which are illustrated in the accompanying drawings.

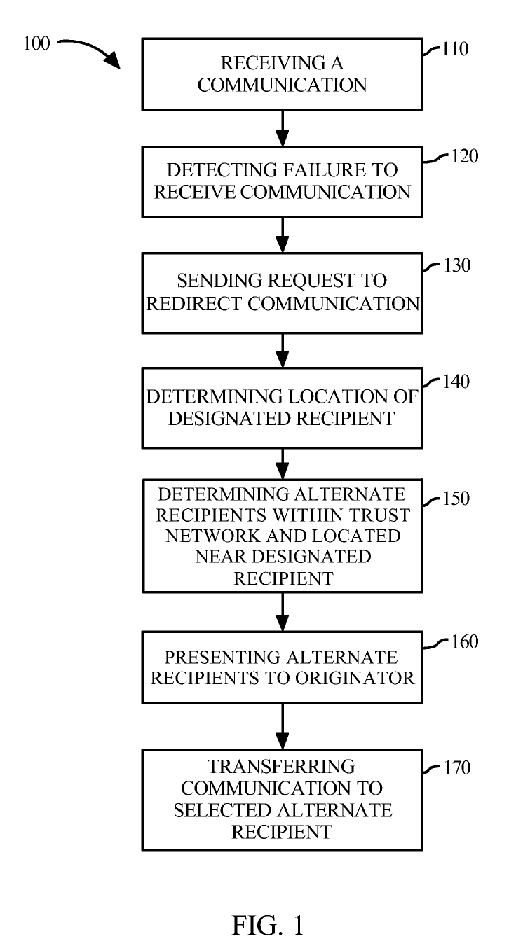

Referring to FIG. 1, a method 100 for redirecting communication in accordance with an embodiment of the invention is shown. Method 100 for redirecting communication may receive a communication 110. It is contemplated that communication may include a mobile phone call, for example, a cellular telephone call. Communication may also include a text message. Method 100 may detect a recipient's failure to receive communication 120. Method 100 may send a request to redirect communication 130. Method 100 may determine an approximate geographical location of a designated recipient 140. Method 100 may determine at least one alternate recipient within a trust network selected by said designated recipient that is located within said approximate geographical location 150 and may present alternate recipients within a trust network located within said approximate geographical location to the originator 160. Method 100 may transfer communication to a selected alternate recipient 170. In the instance of an emergency situation, alternate recipient may receive information concerning the emergency situation and may notify the recipient.

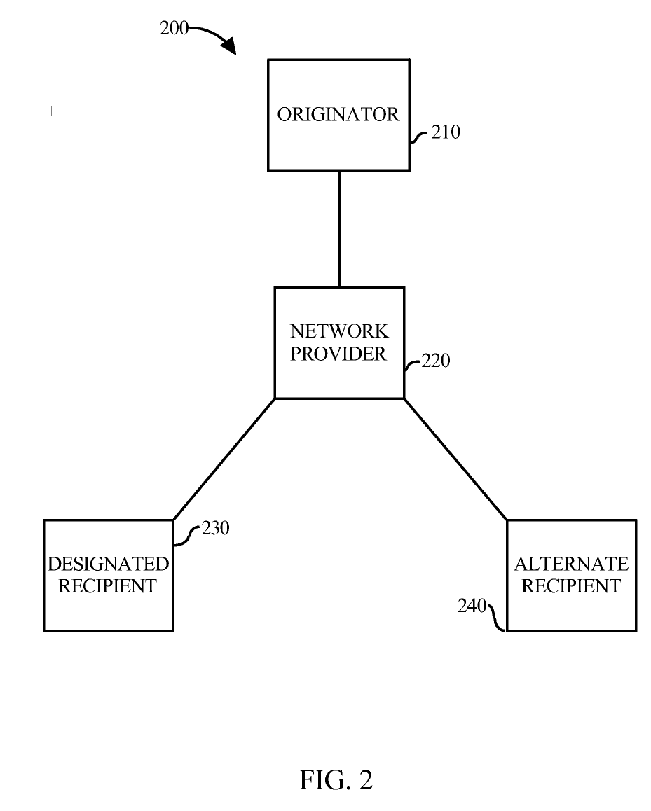

Referring to FIG. 2, a diagram of a routing system 200 in accordance with an embodiment of the present invention is shown. Routing system 200 may include an originator 210, a network provider 220, a designated recipient 230 and an alternate recipient 240. Originator 210 may be a caller or writer of a text message. In an embodiment of the invention, network provider 220 may be a wireless network provider such as a cellular network. Network provider 220 may execute method 100 for redirecting communication of FIG. 1 in accordance with an embodiment of the present invention.

It is contemplated that an alternate recipient may be selected by a network provider 220 based upon geographical considerations and known contacts. Network provider 220 may be able to determine a last known geographical location and an estimated geographical location. A last known location may be determined through use a triangulation system in their cells of a network provider. Additionally, many mobile devices include geographical positioning system (GPS) receivers. Through knowledge of a last known geographical location and current movement information, network provider 220 may accurately determine a last known location and estimate a current geographical location. Mobile device may include any device operable within a cellular network, such as a cellular phone, personal digital assistant, and the like.

In an embodiment of the invention, the network provider 220 may select the alternate recipient based upon alternative recipient's geographical location in proximity to the designated recipient. It is contemplated that recipient may be capable of selecting a maximum distance for rerouting. For example, rerouting may be performed within a circular region such as a circular region of a radius of a few hundred meters, one-half mile, and the like.

Network provider 220 may further select an alternate recipient 240 based upon a prior relationship between the designated recipient and the alternate recipient. A trust network may be established with the network provider 220. A trust network may refer to a group of people that forward calls and messages for a designated recipient. Trust networks are often based around emotional closeness of the participants and this may be a key factor when determining whether to include someone in a given network.

Social networking sites, such as Facebook, may be employed with the network provider 220. It is contemplated that separate social network sites could be employed whereby communication would only be re-routed to particular alternate recipients. For example, a person may participate in several Facebook networks, such as work, neighborhood, family, sport team and the like which may be separate and distinct. If the social networking site also stores contact information, this information may be transferred to the network provider.

In one embodiment, alternate recipient may be selected from a list of contacts appearing in the designated recipient's address book. Network provider 220 may obtain a copy of the address book of each party and may back up the address book as a background activity. Within the list of contacts of an address book, a recipient may also register selected contacts as suitable alternate recipients. For example, some people may only want calls rerouted to friends or family, and not to business acquaintances who may also be in the address book.

As stated, method 100 for redirecting communication may be employed with phone calls directed to a mobile device of a recipient and may also be implemented with text messages directed to the mobile device of a recipient. As with rerouting phone calls, it should be the choice of the caller whether the text messages are rerouted. It is also contemplated that a designated recipient may select potential alternate recipients.

It is further contemplated that a caller's address book may also be employed for redirecting communication, instead of the recipient's address book (or a combination of the two to either increase the possible recipients or to ensure they are known to both parties). It is also contemplated that a designated recipient may prefer particular members of an address book are not utilized as possible alternate recipients and this may be permitted by the network provider. Also, network provider may also permit possible alternate recipients from removing themselves from the responsibility of being a possible alternate recipient of a designated recipient. Also, a list of possible alternate recipients may be presented to a caller with estimated distances from the required recipient (to allow the caller to select the alternate recipient). Additionally, it is contemplated that particular callers may be redirected in a particular way. For example, a child may attempt to call his/her mother. If the mother should not be available, the call may be transferred to the child's father. If the father is unavailable, then it may go to alternate recipients of the mother and/or father.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for redirecting communication, comprising:
receiving a communication, said communication being at least one of a mobile telephone call or text message;
detecting a failure to receive said communication by a designated recipient, said designated recipient is a communication device associated with a first individual;
sending a request to an originator of said communication to redirect said communication, said originator is a communication device associated with a second individual;
determining an approximate geographical location of said designated recipient, said approximate geographical location is determined by at least one of cell triangulation and global positioning system;
determining at least one alternate recipient within a trust network selected by said designated recipient that is located within a geographical area surrounding said approximate geographical location, a size of said geographical area surrounding said approximate geographical location being selected by said designated recipient, said trust network being determined from an address book of said communication device associated with said designated recipient;
presenting said at least one alternate recipient within said trust network selected by said designated recipient that is located within said geographical area surrounding said approximate geographical location of said originator and an approximate distance of said at least one alternate recipient to said designated recipient; and
transferring said communication to one of said at least one alternate recipient selected by said originator, said at least one alternate recipient is a communication device associated with a third individual.
